(19) United States
(12) Patent Application Publication
(10) Pub. No.: US 2014/0365312 A1
(43) Pub. Date: Dec. 11, 2014

(54) MOBILE DEVICE GROUP APP PROVIDING CUSTOMIZED INTERACTIVITY

(71) Applicant: App Giraffe, LLC, Parma Heights, OH (US)

(72) Inventors: Gregory R. Clement, Brunswick, OH (US); Joseph P. Singleton, Olmsted Township, OH (US)

(21) Appl. No.: 14/298,007

(22) Filed: Jun. 6, 2014

Related U.S. Application Data
(60) Provisional application No. 61/832,407, filed on Jun. 7, 2013.

(51) Int. Cl. G06Q 30/02

(52) U.S. Cl. CPC G06Q 30/0269
USPC 705/14.66

(57) ABSTRACT

Disclosed is a system that may be used by a parent organization or group that allows local entities who are part of the group or parent organization to customize and distribute messages to local customers or other users of a software application provided by the parent organization that may be preloaded with generic messages. Also disclosed are examples of processes and systems providing local members of the group with options controlling how input or data is processed when it is received from customers responding to the customized messages.

### CROSS-REFERENCE TO RELATED APPLICATION

This application claims the benefit of U.S. Provisional application No. 61/832,407 filed Jun. 7, 2013, which is hereby incorporated by reference in its entirety.

### BACKGROUND

Mobile devices are generally characterized by a portable hand-held package that typically combines hardware and software for phone and/or internet communication, visual/graphical interaction such as view digital photographs or playing video games, and audio input and output that may include responding to verbal commands or playing music. Mobile devices can also include other sensors or equipment such as Global Positioning Satellite (GPS) equipment for determining the location of the device, WiFi network transceivers, a cell phone transceiver, accelerometers, digital camera, and others.

Such devices can perform a growing number of functions, typically by running various individual computer software applications, commonly referred to as “apps.” Apps are commonly configured to provide a limited set of functions meaning many apps may be used in concert to provide a broader range of functionality. In contrast, general computer software programs are often designed to provide a broad range of related functions within a single program. Programs therefore tend to be larger and more complex than apps, and may require larger or more sophisticated hardware to run them. However, both apps and programs may be executed on a mobile device, or a more traditional desktop computer.

One type of functionality apps can provide is interactive communication between a mobile device user and a particular parent organization or corporate entity such as a church or a chain of banks, retail stores, hotels, restaurants, or theaters to name a few. Functionality offered by corporate apps includes sending advertising, viewing loyalty card or account information, event or sales notifications, providing coupons, browsing a product catalog and taking orders, displaying account balances, taking payments, depositing checks, scanning bar codes for product information, and identifying the nearest local branch, store, or other entity that is part of the corporation or parent organization.

Local entities are part of the parent organization but interact typically with customers at local storefronts or physical locations. For example, retail or fast food chains may have several separate locations in a metropolitan area. The content included in customer messages for mobile devices is often administered by a management interface operated by a staff representative of the parent organization. Communications content appearing in the corporate app is therefore usually the same for all local entities that are part of the organization. Any content variation for a local operator, franchise, or other entity is typically programmed for selection from a predetermined set of options that cannot be changed without changing these options for every other local entity. Such changes often require expert help from software engineers as well, making it less likely to occur even though the changes may be very desirable. This can create complexities for local entities who wish to communicate specific content to their customers through the corporate app because each entity may wish to offer content that may be different from the content provided by the parent corporation and/or different from other nearby local entities.

As a result, local entities have reduced flexibility in communicating with their local customers. For example, a pizza corporation may use its app to offer a special sale price for large pepperoni pizzas. However, a local pizza establishment operating as part of the corporation may want to promote an alternate pizza offering (perhaps its clientele prefer vegetables), particularly after running out of pepperoni. With a conventional corporate app, the local entity may be unable to timely communicate important messages to its customers and distribute these messages via the corporate app provided by the parent organization. This can result in lost marketing opportunities or substantial added cost and complexity for local operators.

### SUMMARY

Disclosed is a computer implemented software system for customizing interactions with local customers of a local entity which is part of a parent organization. The system provides local entities with the opportunity to customize corporate messages and distribute those messages to local customers using an application provided by the parent organization. The system provides access to local entities and maintains information about them such as their geographical location, store hours, contact information, and the like.

Local entities may use software provided by the system to configure customized versions of messages initially created by the parent organization. These customized messages can include content specific to the individual local entity. The local entity may then use the system software to distribute its own customized messages using the corporate app, allowing customers to view them on a personal computing device (such as a mobile phone, tablet, and the like). Customers may designate a particular local entity and then receive the customized messages provided by that particular entity.

The system software may be configured to accept input from a local entity user defining various message attributes along with the customized message defining the circumstances under which the message should appear to a customer. For example, a customized message may only appear to customers for a certain period of time, or only if the personal computing device is within a geographical area defined by the local entity. Customized messages may include text, images, banner advertisements, or other sections of a page or screen as well as push notifications, e-mails, or any other messages or content the corporation may allow local entities to customize.

### BRIEF DESCRIPTION OF THE DRAWINGS

FIG. 1 is a schematic diagram illustrating many of the components of the disclosed software system for customizing interactions with local customers of a parent organization.

FIG. 2 is a flow chart illustrating one example of an initializing access to the system of FIG. 1 for a parent organization or local entity user.

FIG. 3 is a flow chart illustrating one example a process for modifying messages displayed to a customer using the system of FIG. 1.

FIG. 4 is an example of a user interface that may be displayed by the system of FIG. 1 for accepting location specific message criteria.

FIG. 5 is a flow chart illustrating one way the system of FIG. 1 may be configured to display customized messages to a customer.

FIG. 6 is a flow chart illustrating another example of how the system of FIG. 1 may be configured to display customized messages to a customer.

FIG. 7 is a flow chart illustrating how the system of FIG. 1 may be customized by a local entity to respond to customer input.

FIG. 8 is a diagramatic view with additional detail for other components that may appear in the system of FIG. 1.

### DETAILED DESCRIPTION

For the purpose of promoting an understanding of the principles of the invention, reference will now be made to the examples illustrated in the drawings and specific language will be used to describe the same. It will nevertheless be understood that no limitation of the scope of the invention is thereby intended. Any alterations and further modifications in the described examples, and any further applications of the principles of the invention as described herein are contemplated as would normally occur to one skilled in the art to which the invention relates. At least one example of the invention is disclosed in detail, although it will be apparent to those skilled in the relevant art that some features that are not relevant to the present invention may not be shown for the sake of clarity.

Illustrated in the figures and described below is a computer implemented software system for customizing interactions with local customers of a local entity which is part of a parent organization such as a corporation, religious denomination, school system, and the like. The system allows local entities like local franchise owners, churches, individual schools, and the like to customize and distribute messages to customers, parishioners, students, or other interested parties who are users of an app provided by the parent organization (i.e. a “group app”). The system operates by allowing app users (or possibly the app itself) to designate a local entity. The app can then control messages displayed to the user by displaying generic messages provided by the parent organization, or customized messages provided by the designated local entity if any such messages have been defined. In this way local members of the parent organization can control messages to their current or prospective customers based on local interests without the additional complexity of creating and/or maintaining a separate app.

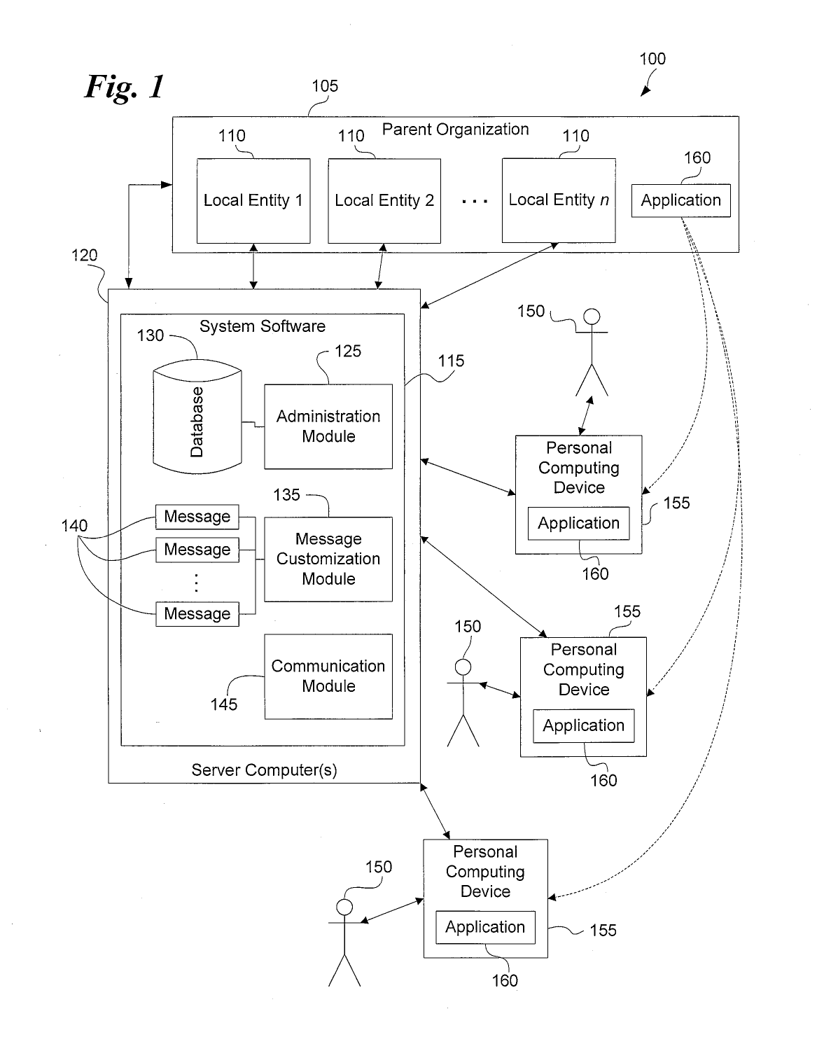

As illustrated in FIG. 1, multiple local entities 110 can be associated with a parent organization 105. Three local entities 110 are shown, but any number may be present as part of the group. Both local entities 110 and parent organization 105 may access system software 115 which can provide access to various aspects of the system such as administrative, customization, and user interaction functionality.

Administrative functionality may be organized within system software 115 in an administrative module 125 and includes controlling access to system software 115 or adjusting the availability of various system options for different users or groups of users. The administrative functionality in system software 115 may access a database 130 which can contain various data about local entities and system users such as user login credentials, data defining the relationships between a parent organization and its associated local entities, the ID and location of individual local entities, and the like.

System software 115 can also include message customization functionality which may be included in a message customization module 135. The message customization aspects of system software 115 can provide access to one or more messages 140 maintained by the parent organization 105 and local entities 110. Access to messages 140 can include functionality for adding new messages and creating new versions of existing messages and saving them. In the context of the disclosed system, a “message” may be a string of text, an image, a banner advertisement, an e-mail message, a portion of a web page in HTML, a user interface software component for insertion into a user interface in an application, an XML payload, and the like. A “message” as used herein may also include a screen or page template, or any dynamic or interchangeable elements used within a template.

The system software 115 may include user interaction or communication functionality which may be implemented as a communication module 145. Communication functionality may be configured to broadcast or distribute customized messages to users such as customers 150 of local entities operating personal computing devices 155 executing an application 160. Communication functionality can also include customizable rules or processes for handling input or data provided by the users 150 to system software 115 using application 160.

Parent organization users or local entity users may access the system to perform administrative, message customization, user interaction, and other tasks. For example, corporate users may login and create generic messages for display in the group app, or administer access to various features and functionality available to the local entity users. Local entities can access the system to create a new message, create customized versions of existing messages, enter message criteria defining when an app user will see a message, request that a message be sent immediately, or review input submitted by a user.

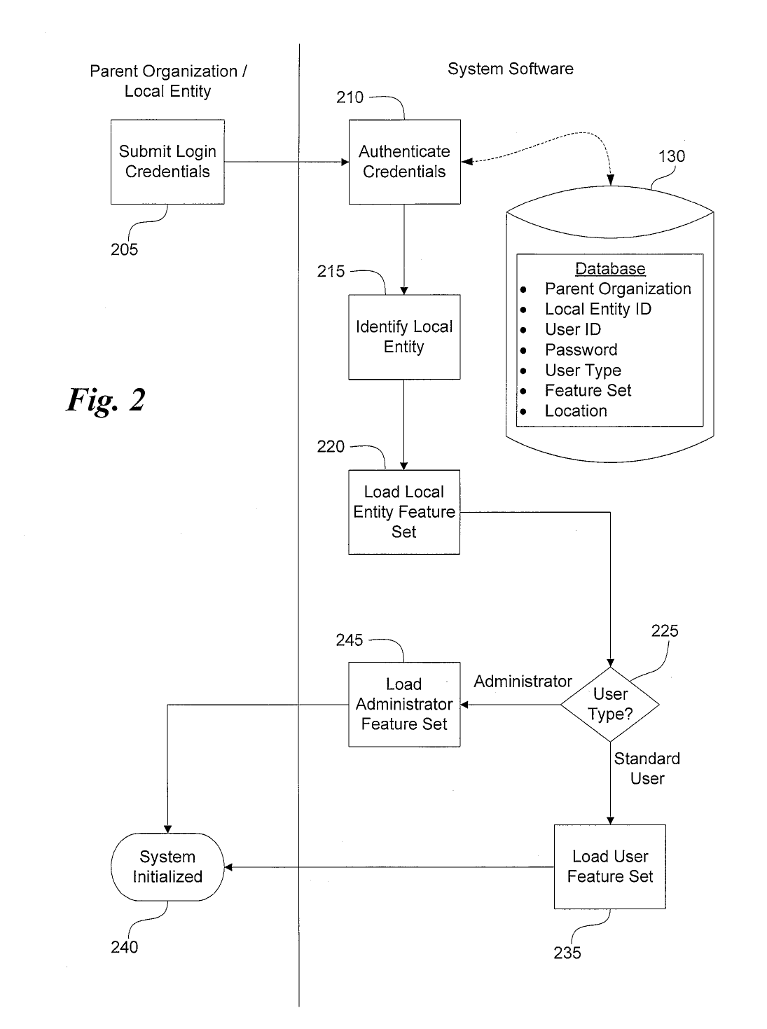

Parent organization or local entity users can access system software 115 after authentication has taken place. An example of the authentication and feature set initialization process is illustrated in FIG. 2. Parent organization 105 or local entity 110 may submit login credentials which can include information such as a user ID, password, or other information for identifying a registered user of the system software 115. System software 115 can authenticate the user (210) by, for example, accessing database 130 to retrieve necessary identifying information to compare with the credentials submitted by the user. Examples of this information are illustrated in FIG. 2 and include the parent organization, the local entity ID, user ID, password, user type, and others. The submission of login credentials (205) and authentication of the user (210) may be repeated until authentication succeeds at 210.

Based on the login credentials, system software 115 can determine whether the user is a parent organization user or a local entity user. When a local entity is identified, system software 115 can identify the local entity (215) for the user, and can present a corresponding local entity feature set (220). User attributes such as user type may also be compared with a set of rules to determine a feature set to load corresponding with the type of user retrieved from database 130 for this user. In this example, if the user is a standard user (225) a user feature set may be loaded (235) resulting in an initialized system (240). If the user type is an administrator (225) then system software 115 may present an administrator feature set (245).

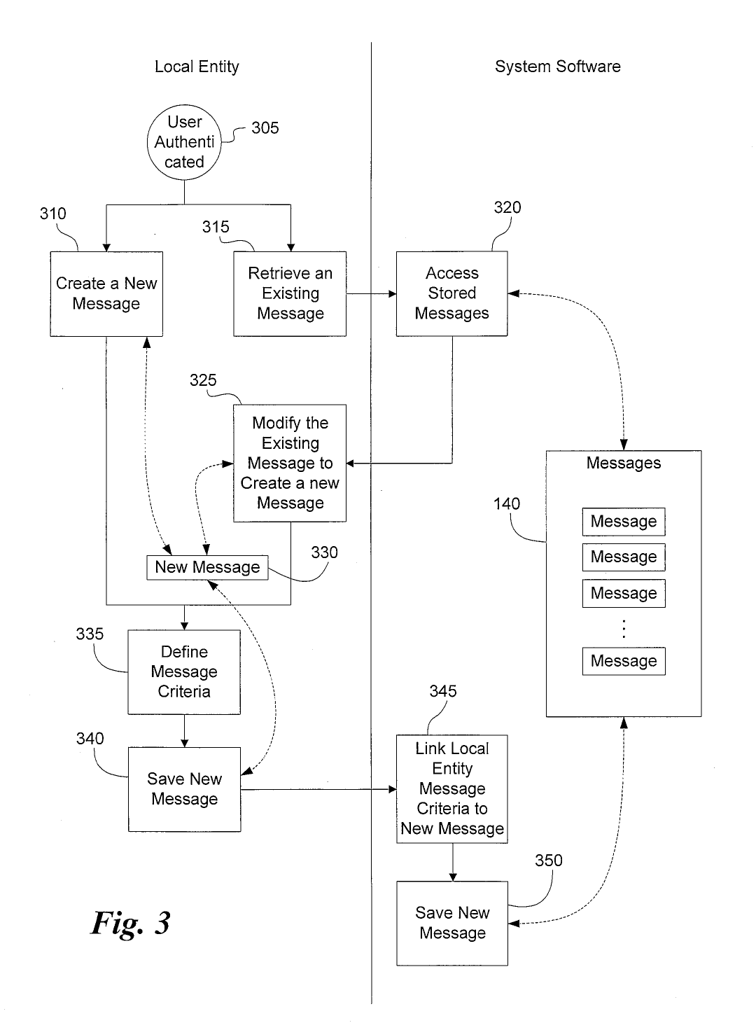

Illustrated in FIG. 3 is one example of a process for storing customized messages using the disclosed system software 115. In this example, an authenticated local entity user (305) can create a new message at 310, or create a new version of an existing message at 315. Other options may be presented to the user by system software 115 as well, such as editing or deleting customized messages.

In the case were the user decides to customize an existing message, the user can access stored messages (320). Information about messages 140 may then be displayed or otherwise presented to the local entity user via a user interface generated by system software 115. The user may then select a message 140 to customize from the user interface, and the message may be retrieved (315) and presented to the user for editing. The local entity user may modify the existing message (325) to create a new message 330 customized according to the specific needs of the particular local entity. Examples of these customizations include, but are not limited to, special offers, promotions, coupons, or pricing restricted to a particular time period, location, product and the like. Other examples of customized messaging include messages about upcoming events, changes to operating hours, emergency information, and the like.

Another example of creating a customized message involves creating customized messages using template or “form” messages created with empty areas or fields configured to accept custom input. The local entity user may select the template message 140 from the available messages, provide content such as images, text, and the like for the template fields. When the template has been filled out, the user may save the new version of the template with the additional content as a new message. These template messages may be used by both local entities and the parent organization to maintain a standard appearance for all messages while reducing the effort required to create a new message.

When the customization of the new message at 325 is completed, the local entity user may be allowed to define message criteria at 335 indicating the circumstances under which the new message 330 may appear. For example, the software may provide a user with an interface for defining a named location, a predefined boundary, or a custom defined boundary thus restricting the display of new message 330 to users with computing devices 155 located within a particular geographical area. This geographical area may include the location of the local entity itself, or it may be a separate area that does not include the local entity. Display criteria for a message may also include an expiration date and time, a user action requirement such as submitting an order, responding to a survey or poll, or sending an invitation to a friend to join the customer 150 using the application for an event or purchase a product, subscription, or service. The defined message criteria may then be saved (340) along with new message 330 using system software 115. System software 115 may receive the new message and process it by linking the new message 330 to the message criteria defined by the user and saving it (350) with the other messages 140. The new message (which may be a customized version of a message provided by the parent organization) can be retrieved later by customers or users 150 using the application 160 on a personal computing device 155 such as a mobile phone, tablet, personal computer, or other computing device.

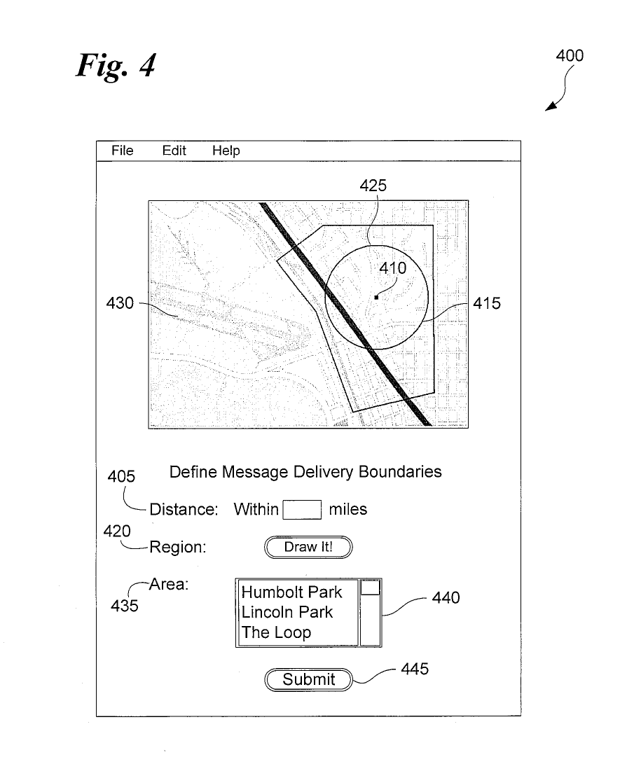

One example of a user interface that may be presented by system software 115 for defining geographical message criteria is illustrated in FIG. 4 at 400. FIG. 4 is illustrative in that any suitable collection or arrangement of controls for collecting user input defining when a customized message may appear or disappear from application 160 may be used.

User interface 400 may be configured to accept, among other inputs, user input defining geographical boundary criteria for new message 330. For example at 405 the user may input that a particular message should only be visible within a certain number of miles 415 of the local entity's location which may be displayed to the user as an icon or other indicia 410 superimposed over or rendered along with a map 430. A perimeter criteria like 405 may appear in the user interface as a substantially circular line with the location 410 of the local entity at about the center. In another example at 420, a user may select to draw or otherwise indicate a user defined region which may appear on map 430 as an irregularly shaped polygon 425 indicating an exclusion boundary outside which message 330 may not be shown. In another example, a user may select a pre-defined region or area from a list of predefined areas 440. These areas may, for example, be defined by political, ethnic, or other boundaries such as named officially designated community areas, zip codes, burroughs, wards, subdivisions, towns, neighborhoods, districts, or hamlets, including unofficially named areas such as ethnic enclaves, and the like. Having provided any suitable combination of these inputs, the user may then submit the message criteria at 445 allowing it to be submitted with message 330 as discussed herein elsewhere.

Customers interact with the system using a group app such as application 160 provided by the corporation. The app can present the most recent communications from a local entity as the user is making decisions such as while shopping, traveling, site-seeing, or at a conference or sporting event. Therefore it can be advantageous to run application 160 as a group app on a mobile personal computing device 155 that is small and portable such as a smart phone or tablet. The application 160 may be operable, but may be less advantageous on larger portable computers such as laptops, or perhaps on even larger and more stationary computers like desktop computers or servers.

When using the app, users can specify which local entity they designate, or the app may instead automatically designate a local entity. Customers or other app users can then receive general corporate messages and customized messages from the designated local entity. Designating a local entity also allows customers to receive timely direct communications such as push notifications sent by the local entity. Users can respond to the messages they receive and may submit information directly to the local entity based on delivery options specified along with a customized message. Using this system, a user may anonymously request to receive communications from a local entity of a larger corporation without being required to maintain their personal information on a corporate website. In other words, the local entity can communicate with customers who have designated that local entity without the local entity necessarily having a contact list or even knowing who those customers are. Conversely, local entities are also able to communicate directly with local clientele using an app already provided by the parent organization, thus avoiding the additional cost and complexity of building their own custom app or maintaining a local database of contact information or messaging preferences for current and future customers.

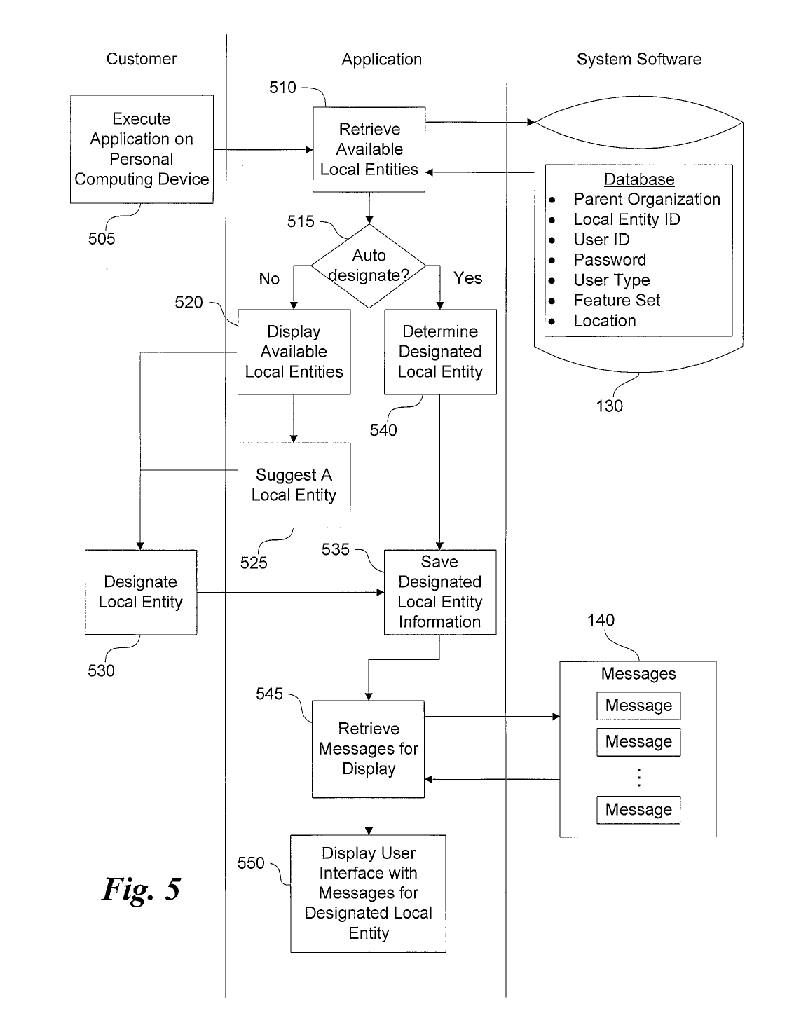

In FIG. 5 at 505, the customer can execute application 160 on personal computing device 155. Application 160 may retrieve available local entities (510) from system software 115 and return information about the available local entities to application 160 based on local entity data stored in database 130 or elsewhere in the system. Available local entities may be determined by any suitable means such as by querying database 130 for all local entities within a predetermined distance from the personal computing device 155′s current location as automatically determined or manually entered, by selecting a predetermined number of the closest local entities 110, or by displaying a list of all the local entities 110 appearing within a predefined boundary such as a municipality, county, state, region, and the like, particularly where computing device 155 is also within the same boundary.

When available local entities have been retrieved, application 160 may automatically designate a local entity, for example, as the customer travels passing by various local entities along the way. This auto-designation functionality may be an option configured in the application that may be activated or deactivated by the user. In another example, the application 160 may be configured to execute actions 510 through 540 each time the user activates the application 160 in order to refresh the designated local entity, or to allow the user to select a new local entity. This refresh functionality may also be an option that a customer can activate or deactivate.

If the auto-designate feature is enabled (515), application 160 may not display available local entities as at 520, but may instead determine a designated local entity (540) using a rule or set of rules. For example, application 160 may select the local entity geographically closest to the customer and computing device 155. Application 160 may also select the local entity 110 that is the largest, has the widest range of product offerings, or is currently open based on the local entity's published hours of operation, the time of day and the day of the year. Any suitable rules or screening techniques may be employed to determine an auto-designated local entity at 540.

If the auto-designate feature is not enabled (515), application 160 may display the available local entities (520) and may also suggest a local entity (525). Customer 150 may designate a local entity (530) by any suitable process such as by selecting one of the available local entities 110 from a list, by selecting a local entity 110 from a map with icons representing the location of each local entity, or by confirming the local entity suggested at 525. Application 160 may then save the designated local entity information selected by the user (535) making it available for later comparisons.

When a local entity is designated, the application 160 and the system software 115 can work together to present to the user generic messages, customized messages, or both. Application 160 may receive messages from the system and apply filtering logic to show only some of the messages and suppressing others. Alternatively, the message filtering logic may be applied in the system software 115 before application 160 receives the messages to display.

For example, system software 115 may provide all the current messages to application 160 including general corporate messages and customized versions of those messages if any are available. Application 160 may then filter messages suppressing some and displaying others if the message criteria matches the designated entity ID and other criteria defined by the local entity such as the location of the personal computing device 155, and the local date and time. In this example, application 160 may choose to replace a general message provided by the corporation with a customized version of the message created by the local entity. On the other hand, the customized message may be suppressed in favor of the corporate message, or in some instances neither message may appear depending on the criteria associated with the messages.

In another embodiment, application 160 may query server software 115 using the designated entity ID and any other data associated with the personal computing device such as a location or saved customer profile data. In this example, server software 115 may choose a local entity specific customized version of a general corporate message, a corporate message instead of a customized version, or no message at all depending on the application data and the message criteria linked to the messages. In this way, the system software 115 effectively suppresses some messages and allows others to be available for display in application 160 while reducing system resource usage such as memory, storage, network bandwidth, processing time on personal computing device 155, and the like. When messages 140 are loaded, application 160 can proceed to display the customized messages provided by the designated local entity, and/or to display general messages provided by the parent organization (550).

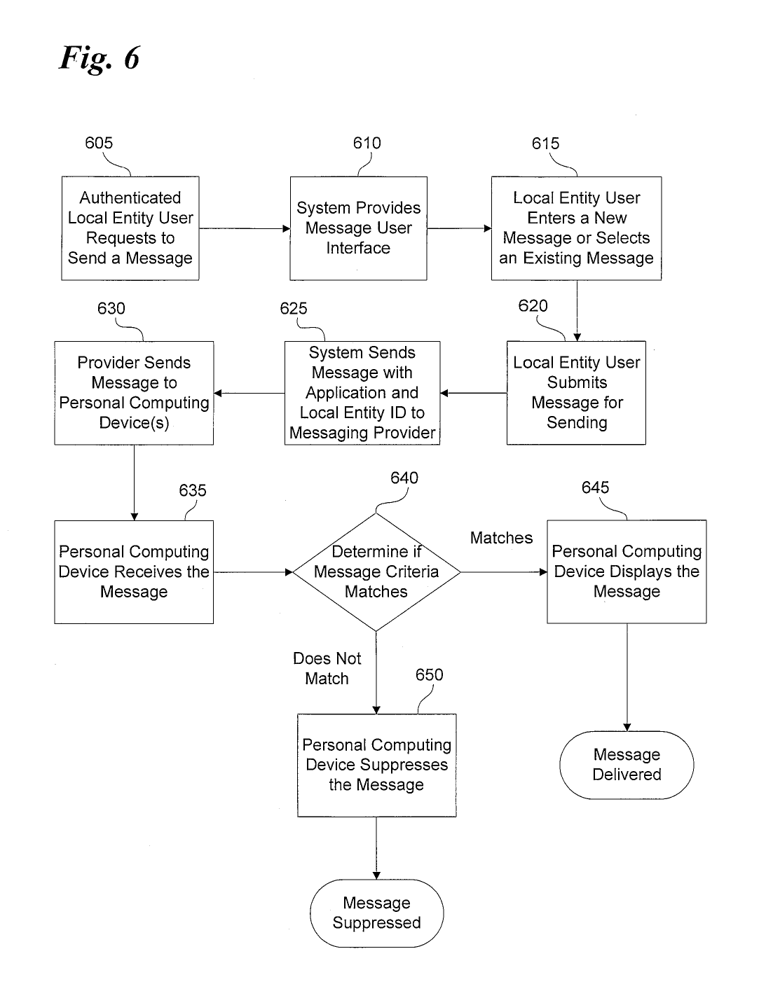

Another example of how system software 115 and application 160 collaborate to present local entity specific messages is illustrated in FIG. 6. An authenticated local entity user requests to send a message (605) using the system software 115. System software 115 may facilitate this interaction by providing a user interface for inputting the message (610). An example of part of such an interface is shown in FIG. 4. The user interface may also include a list of preformatted messages 140 retrieved from the system using a procedure such as the one illustrated in FIG. 5 at 510. The local entity user may enter a new message, create a customized message that is a new version of an existing message, or simply select an existing message 140 at 615. When the selection and customization is completed, the user may submit the message to system software 115 for sending (620) along with any related message criteria. System software 115 may then link the various message criteria defined by the user such as the local entity ID, a location or boundary, and the like and send the information to a third-party messaging provider at 625. The messaging provider can then send the message (630) to all personal computing devices 155 executing application 160 and used by customers 150.

Personal computing device 155 can determine if the message should be displayed based on the message criteria linked to the message. For example, a local entity ID may be linked to the message as discussed above as part of the message criteria. If the message criteria matches the local entity ID designated by the user (640), the message may be displayed (645) and the message delivered. However, if the IDs do not match, personal computing device 150 may suppress the message (650) and the customer may not see it. The message criteria may also include any of the message criteria discussed herein such as a boundary, an expiration date or time, and the like. As with other comparisons with message criteria disclosed herein, various rule configurations are possible. In one example, all criteria must match for the customer to see any customized messages. In another example, only the local entity ID must match while all other criteria may or may not match. Any suitable configuration of rules for determining when to display messages and when to suppress them is envisioned.

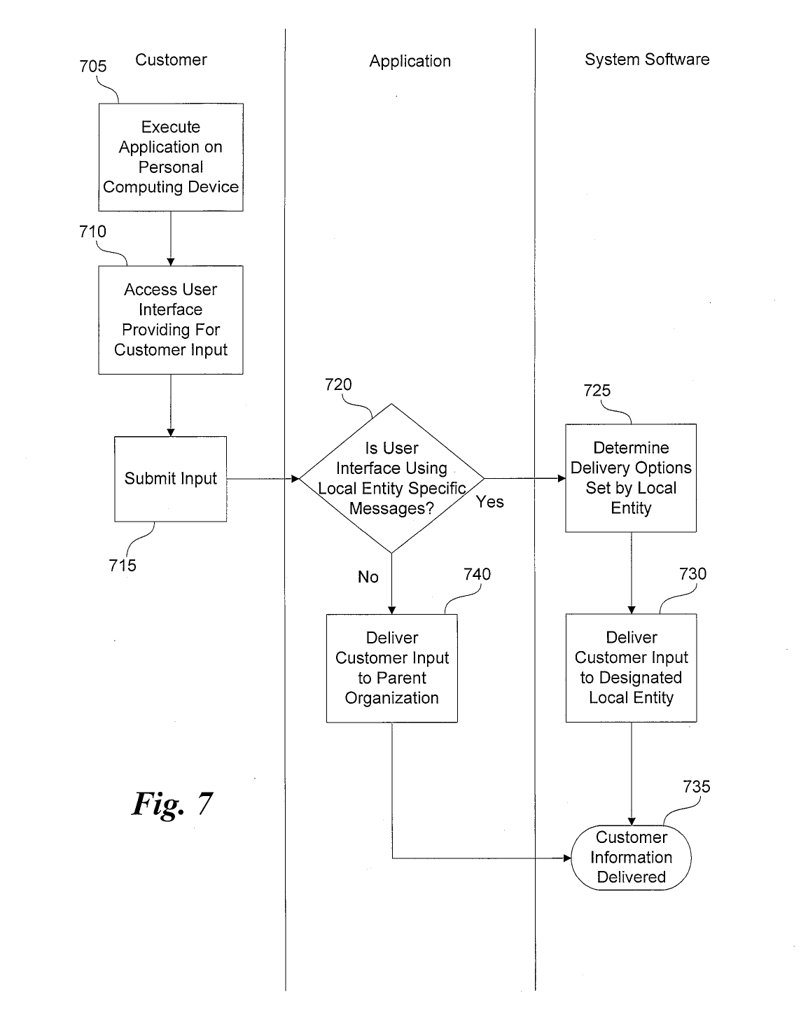

Messages sent to application 160 may also control the type of information that a customer or user 150 of application 160 may send to a local entity. As previously discussed, a “message” can include any page, user interface component, page fragment, banner, image, string of text, word, symbol, or any other element appearing on a user interface generated by application 160. As illustrated in FIG. 7 beginning at 705, application 160 running on a personal computing device 155 can access a user interface within application 160 that may provide for customer input or feedback (710). The user may then supply customer input (710) and submit this input (715) to system software 115 for processing.

Customer input can take any form and can include submitting feedback on a customer feedback page, submitting a vote on a customer poll, submitting an order to purchase products or services, submitting a customer service feedback form, submitting a product review, and the like. If the user interface is using local entity specific messages (720), application 160 can request system software 115 process the customer submission using local entity specific delivery options (725) linked to the customized messages. The customer input can then be delivered to the designated local entity according to these options (730) specified by that particular local entity. For example, the designated local entity may have requested to view the customer feedback or input as an e-mail which can be delivered directly to an e-mail address the local entity 110 designated for this purpose. In another example, the data submitted by the customer 150 as customer input may be submitted to the local entity 110 as a web service call, or other similar data feed, such as in the case of an order submission. Other delivery options may be provided to local entities as well. In any case, the customer information is delivered (735) to the local entity 110 according to its needs and ability to process the information without encumbering resources of parent organization 105 to handle the information. Where no local entity specific messaging options have been specified for the user input (720), the user information may be delivered directly to the parent organization for processing (735).

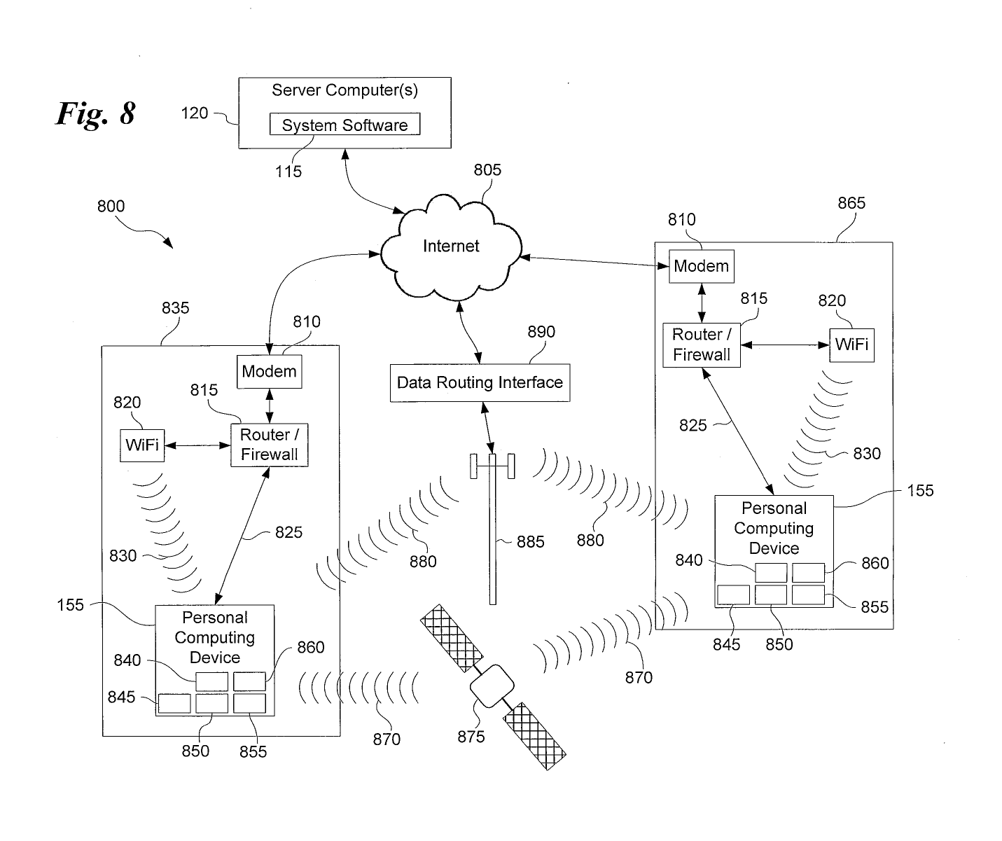

Various implementation details are illustrated in FIG. 8 at 800. The system software 120 can execute on server computer 120 and application 160 may execute on personal computing device 155 as discussed above. A server computer 120 and personal computing device 155 are both examples of a computer or computing device operating in the overall system 800 as herein disclosed. Either one or both of server computer 120 and personal computing device 155 may include one or more processors or CPUs and one or more types of memory. Each memory may include a removable memory device. Each processor may be comprised of one or more components configured as a single unit. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM, i3, i5 or i7 processors commercially available from INTEL Corporation of 2200 Mission College Boulevard, Santa Clara, Calif. 95052, USA.

Each memory (removable or generic) is one form of a computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Server computer 120 represents a “server computer” in the generic sense and may be a single, physical, computing device such as a desktop computer, a laptop computer, a rack mounted server, or it may be composed of multiple devices of the same type such as a group of computers operating as one device in a networked cluster, or a heterogeneous combination of different computing devices also linked together by a network and operating as one computer. Thus computer 120 may be composed of one or more physical computing devices having one or more processors and memory as described above.

Computer 120 may also include a virtual computing platform having an unknown or fluctuating number of physical processors and memory devices supporting the operation of the systems described above. Likewise, computer 120 may be located in one geographical location or spread across several widely scattered locations with multiple processors linked together to operate as a single computer connected by a network. Just as the concept of a computer is not limited to a single physical device, so also the concept of a “processor” is not limited to a single physical logic circuit or package of circuits but includes one or more such circuits or circuit packages possibly contained within or across multiple computing machines in various physical locations.

The concept of “computer” and “processor” within a computer or computing device also encompasses any such processor or computing device serving to make calculations or comparisons as part of disclosed system. Processing operations related to threshold comparisons, rules comparisons, calculations, and the like occurring in server computer 120 and personal computing device 155 may occur, for example, on separate servers, the same server with separate processors, on a virtual computing environment having an unknown number of physical processors as described above, or on a handheld computer such as a table, smart phone, or laptop.

As illustrated in FIG. 8, personal computing device 155 may be used by a corporate or parent organization 835, or any member thereof such as a local entity, or by a customer or user 865. Computing device 155 may include any combination of a processor 840 and a memory 845. A GPS receiver 850 for receiving signals 870 sent by a GPS satellite 875 can be used to determine the geographical location of personal computing device 155. A network interface (wired and/or wireless) 855 may be included as well to facilitate communication with various networks as disclosed blow. Software 860 configured to interact with system software 115 may include a custom application such as application 160 developed by or for parent organization 105, or an internet browser configured to interact with software provided by server computers 120 such as in a Software-as-a-Service (Saas) implementation. Examples of commercially available internet browsers include Google Chrome, Apple Safari, Mozilla Firefox, and Windows Internet Explorer to name a few.

No limitation with respect to size, capability, specifications, intended purpose, mobility, or any other features or aspects of computing device 155 is intended in the use of the term “personal” with respect to personal computing device 155. Any computer or computing device disclosed herein may be suitable as a personal computing device and any representations provided with respect to computing device 155 or server computers 120 are illustrative and not restrictive in nature.

Server computer 120 and personal computing device 155 may be coupled to, or be integrated with, a display device. Likewise, display devices may be of the same type, or a heterogeneous combination of different visual devices. Any of the servers, computers, or computing devices herein disclosed may also include one or more operator input devices such as a keyboard, mouse, touch screen, laser or infrared pointing device, or gyroscopic pointing device to name just a few representative examples. Also, besides a display, one or more other output devices may be included such as a printer or plotter. As such, various display, input and output device arrangements are possible.

The data and operating logic of the system described above can be embodied in signals transmitted over a network, in programming instructions, dedicated hardware, or a combination of these. Thus communications with the system can be achieved by various means such as a wireless or wired Local Area Network (LAN), Municipal Area Network (MAN), Wide Area Network (WAN), such as the Internet, a combination of these, or such other network arrangements as would occur to those skilled in the art. Examples of some aspects of these communications networks appear in FIG. 8 as well. Personal computing device 155 is configured to communicate over these kinds of networks via a wired connection 825, or via wireless network connection 830 to a WLAN (or WiFi) transceiver 820. These communications may pass through a router or firewall or any combination thereof 815 and modem 810 before passing over a larger computer network or series of computer networks such as the internet 805. Communications can also reach the internet 805 as wireless data transmissions carried over signals 880 exchanged with a cellular transmitter/receiver 885 which can be passed through a data routing interface 890. Signals 880 may conform to any of a number of mobile telecommunications technology standards such as 3G, 4G, and the like.

External data sources may also be connected to the system via data access devices connect to these same communications links, or these data access devices may provide data by other means such as via nonvolatile storage devices such as DVD or CD-ROM, flash memory devices, and the like. Users may also interact with the system by submitting or receive data over the same networks. It shall be appreciated that in alternate forms a user may submit data in an HTML form submission, submit orders, exchange text messages, e-mails, view reports generated by the system as well as other relevant information on computing devices 155 such as a PDAs, Blackberries, iPhones, iPads, smart phones or tablet computers, to name just a few illustrative examples.

In one embodiment, users interact with the system via one or more software applications operating on server computers 120 which serve HTML pages, sends and receives data via web services, and/or other Internet standard or company proprietary data formats, or maintain dedicated client/server connections in order to facilitate the transfer of information between the users and the system software 115, or between the system and outside data sources. As described above, this interaction can take place over a network such as the internet 805, a WAN, MAN, LAN, or other suitable electronic communications network. Further, it shall be appreciated that the types of communication methods connected within the above described system need not be of the same type, but that digital, analog, and other technologies may be accommodated simultaneously.

A database such as database 130 disclosed herein may be any suitable data storage device or software executing on a computer or other device. Some examples include a Relational Database Management System (RDBMS), an Object Database Management System (ODBMS), a file based database system, a collection of binary or text files, a spreadsheet, or any other suitable mechanism for storing and retrieving data.

While the invention has been illustrated and described in detail in the drawings and foregoing description, the same is to be considered as illustrative and not restrictive in character, it being understood that only some examples have been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

What is claimed is:

1. A system used by a parent organization to allow local entities who are part of the parent organization to customize and distribute messages to users using an application provided by the parent organization, comprising:
an administration module configured to provide access to the system to a plurality of local entities that are associated with a parent organization, wherein the administration module accesses a database storing data about the local entities that includes an ID;
a message customization module configured to provide access to messages stored on a server computer, wherein the message customization module is configured to allow an individual local entity to create a customized version of a message that includes content specific to the individual local entity, wherein the message customization module is configured to link the ID of the individual local entity with the customized version of the message, and wherein the administration module is configured to accept a request from an individual local entity to send a customized message associated with the individual local entity;
a communication module, wherein the communication module is configured to distribute the customized message to personal computing devices of customers in response to a command from the administration module; and
an application provided by the parent organization configured to execute on personal computing devices of customers, wherein the application is configured to designate one of the plurality of local entities for each customer, wherein the application displays the customized message to the customer using the personal computing device if the ID linked to the customized message matches the ID of the designated local entity.

2. The system of claim 1, wherein the application suppresses the customized messages if the ID linked to the customized message does not match the ID of the local entity designated by the customer.

3. The system of claim 1, wherein the message customization module is configured to allow the individual local entity to create a customized message based on a message stored by the parent organization.

4. The system of claim 1, wherein the application accepts geolocation data from the personal computing devices indicating the geographical location of the personal computing device to enable designation of a local entity.

5. The system of claim 4, wherein the application applies rules to automatically select the designated local entity based on the geolocation data.

6. The system of claim 1, wherein application accepts input from a customer specifying the designated the local entity.

7. The system of claim 1, wherein the administration module is configured to accept boundary information from a local entity defining a geographical area, and wherein the system is configured to limit display of the customized message to personal computing devices located in the geographical area.

8. The system of claim 7, wherein the geographical area includes the location of the local entity.

9. The system of claim 1, wherein the customized message sent to the application replaces a message provided by the parent organization.

10. The system of claim 1, wherein a message is sent from the personal computing device to the local entity in response to and linked to a customized message.

11. A system used by a parent organization to allow local entities who are part of the parent organization to customize and distribute messages to users using an application provided by the parent organization, comprising:
a message stored on a server computer;
a database storing data about a plurality of local entities associated with the parent organization, wherein the local entities are identified in the database by corresponding IDs;
an application provided by the parent organization configured to execute on customer personal computing devices, wherein the application is configured to designate one of the plurality of local entities for each customer;
wherein the system is configured to allow a local entity to create a customized version of the message that includes content specific to that local entity;
wherein the system links the ID of the local entity with the customized message;
wherein the system is configured to distribute the customized message to personal computing devices; and
wherein the application is configured to compare the ID linked with the customized message with the customer's designated local entity ID, and to display the customized message if the IDs match.

12. The system of claim 11, wherein the application suppresses the customized messages if the ID linked to the customized message does not match the ID of the local entity designated by the customer.

13. The system of claim 11, wherein the application accepts geolocation data from the personal computing devices indicating the geographical location of the personal computing device and uses the geolocation data to designate a local entity.

14. The system of claim 13, wherein the application automatically selects the designated local entity.

15. The system of claim 11, wherein application accepts input from a customer specifying the designated the local entity.

16. The system of claim 11, wherein the system is configured to accept boundary information from a local entity defining a geographical area, and wherein the system is configured to limit display of the customized message to personal computing devices located in the geographical area.

17. The system of claim 16, wherein the geographical area includes the location of the local entity.

18. The system of claim 11, wherein the customized message sent to the application replaces a message provided by the parent organization.

19. The system of claim 11, wherein a message linked to the customized message is sent from the personal computing device to the local entity in response to input by the customer using the application.
